(19) United States
(12) Patent Application Publication
(10) Pub. No.: US 2014/0253046 A1
(43) Pub. Date: Sep. 11, 2014

(54) METHOD AND APPARATUS FOR BATTERY CONTROL

(71) Applicant: EnerDel, Inc., Greenfield, IN (US)

(72) Inventor: Tomasz Poznar, Wroclaw (PL)

(73) Assignee: EnerDel, Inc., Greenfield, IN (US)

(21) Appl. No.: 14/203,487

(22) Filed: Mar. 10, 2014

Related U.S. Application Data
(60) Provisional application No. 61/776,667, filed on Mar. 11, 2013.

(51) Int. Cl. H02J 7/00

(52) U.S. Cl. CPC H02J 7/0063; H02J 2007/0067
USPC 320/136

(57) ABSTRACT

Generally, a system and a method for controlling a battery to power a load determine a battery temperature and control current flow from the battery based on the battery temperature. If the battery temperature is less than a low temperature, load current is disabled and current is enabled through a resistive load to discharge the battery, at least until the battery temperature is about equal to or greater than the low temperature.

### CROSS-REFERENCE TO RELATED APPLICATIONS

This application claims the benefit of U.S. Provisional Application Ser. No. 61/776,667, filed Marr. 11, 2013, titled METHOD AND APPARATUS FOR BATTERY CONTROL, docket ENERD-012-012-01-US-E, the entire disclosure of which is expressly incorporated by reference herein.

### TECHNICAL FIELD

The disclosure relates generally to energy-based systems, and in particular to a method and a system for battery temperature control.

### BACKGROUND OF THE DISCLOSURE

Energy storage technologies include lithium, nickel metal hydride (NiMH), lead acid (PbA) and nickel cadmium (NiCd), and other chemical technologies. Each technology has advantages and disadvantages. For example, lithium batteries are less tolerant of overcharging than other battery technologies. The available capacity (e.g., watt-hours) of lithium batteries varies as a function of the voltage at which charging is stopped. Capacity degrades with increasing charge voltages. Also, battery capacity is temperature dependent. At a given charge, the power output of a battery is less at a low battery temperature than the power output at a higher battery temperature.

Electrical loads can also be temperature dependent. An exemplary temperature dependent load is an electric starter motor. The starter motor turns the crankshaft of a combustion engine until the engine starts. After the combustion engine starts, the starter motor is disengaged. Starter motors are designed to operate for short periods of time. Problems arise when the engine does not start quickly enough. If the engine stalls, for example, the starter motor can burn up. The engine might stall for several temperature dependent reasons. At cold temperatures, fuel is cold and might not readily ignite. Metal components of the engine might not fit as well causing additional friction. The engine's lubrication system might not flow readily. Thus, combustion engines require higher torque to start in cold weather and may require more time to start if the available torque is not high enough. At the same time, cold temperatures reduce the battery's power output, limiting the starter motor's ability to generate higher torque to overcome the additional load caused by the low temperatures. For the foregoing reasons, starter motor damage does occur due to low temperatures.

A need exists for systems and methods that ensure sufficient power is supplied from a battery to operate a load at low temperatures.

### SUMMARY OF EMBODIMENTS OF THE DISCLOSURE

Embodiments of a method and an apparatus for controlling a battery are provided. In one embodiment, a method for controlling a battery to power a load comprises determining a battery temperature; disabling a load current if the battery temperature is less than a low temperature; enabling a resistive load current through a resistive load to discharge the battery at least until the battery temperature is about equal to or greater than the low temperature; and enabling the load current and disabling the resistive load current if the battery temperature is about equal to or greater than the low temperature.

In one embodiment, an apparatus for controlling a battery to power a load includes a power circuit operable to selectively form a first current path to enable a first current therethrough and to selectively form a second current path to enable a second current therethrough, the first current and the second current being disabled if the first current path and the second current path, respectively, are not formed. The apparatus also includes a resistive load coupled to the power circuit such that at least a portion of the first current flows through the resistive load when the first current path is selectively formed. The apparatus further includes a temperature control logic configured to receive a temperature signal corresponding to a battery temperature and to output a first control signal to cause the power circuit to form the first current path if the battery temperature is less than a low temperature and to cause the power circuit to form the second current path if the battery temperature is equal to or greater than the low temperature.

In a further embodiment, an integrated circuit for controlling a battery to power a load includes temperature logic configured for determining a battery temperature; disabling a load current if the battery temperature is less than a low temperature; enabling a resistive load current through a resistive load to discharge the battery at least until the battery temperature is about equal to or greater than the low temperature; and enabling the load current and disabling the resistive load current if the battery temperature is about equal to or greater than the low temperature.

### BRIEF DESCRIPTION OF THE DRAWINGS

The above-mentioned and other disclosed features, and the manner of attaining them, will become more apparent and will be better understood by reference to the following description of disclosed embodiments taken in conjunction with the accompanying drawings, wherein:

FIGS. 1-2A are perspective diagrams of apparatus configured to control a battery based on the battery's temperature in accordance with examples set forth in the disclosure;

FIG. 2B a block diagram of an integrated circuit in accordance with an example set forth in the disclosure;

FIG. 3 is a flowchart of a method to control a battery in accordance with an example set forth in the disclosure; and

FIG. 4 is a perspective view of a battery comprising multiple battery cells in accordance with another example set forth in the disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present invention. The exemplification set out herein illustrates embodiments of the disclosure, and such exemplifications are not to be construed as limiting the scope of the invention in any manner.

### DETAILED DESCRIPTION

Among other advantages, the above-mentioned and other disclosed features which characterize the embodiments of the apparatus and method described herein advantageously increase a battery power output by discharging the battery to raise its temperature above a low temperature while disabling power output to the load. The low temperature may be predetermined to ensure the power output is sufficient to satisfy load requirements even in low temperatures.

Reference will now be made to the embodiments illustrated in the drawings, which are described below. The foregoing examples and embodiments, and those disclosed below, are not intended to be exhaustive or limit the claims to the precise form disclosed in the following detailed description. Rather, the embodiments are chosen and described so that others skilled in the art may utilize their teachings. Further, the transitional term “comprising”, which is synonymous with “including,” or “containing,” is inclusive or open-ended and does not exclude additional, unspecified elements or method steps. By contrast, the transitional term “consisting” is a closed term which does not permit addition of unspecified terms.

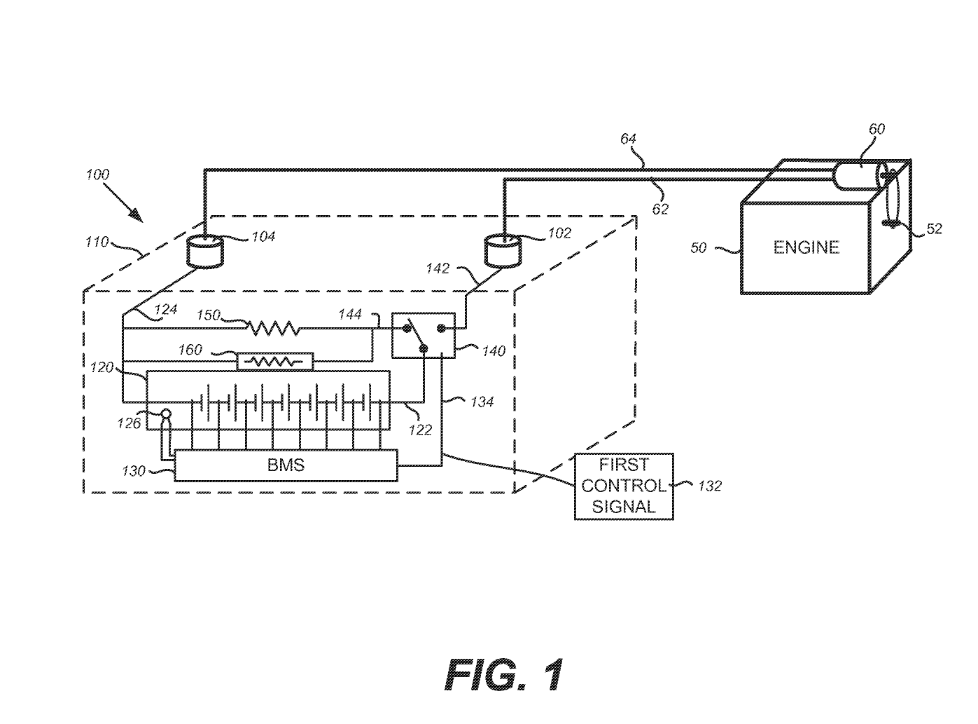

FIG. 1 is a perspective diagram of an embodiment of a battery unit including a temperature control apparatus. In the present embodiment, the battery unit is denoted by numeral 100. Battery unit 100 includes a frame 110 and, enclosed in the frame, a battery 120 including multiple battery cells, a temperature sensor 126 sensing the temperature of battery 120 and a battery management system (BMS) 130 connected to the battery cells and configured to monitor cell voltages. BMS 130 may also include multiple switches (not shown) configurable to charge or discharge specific battery cells to, for example, equalize their voltages. Battery unit 100 also includes positive and negative terminals, respectively terminals 102 and 104. Conductors 62 and 64 are connected to terminals 102 and 104 and to a load. An exemplary load includes a starter 60 of a combustion engine 50. Engine 50 has a crankshaft 52. When energized, starter 60 causes rotation of crankshaft 52 until engine 50 starts. Engine 50 includes starter controls (not shown) that engage starter 60 when necessary if power is available through conductors 62 and 64.

Battery unit 100 further includes a power circuit operable to enable or disable current flow to the load and resistive load 150. An exemplary power circuit is shown, e.g. power switch 140, having at least a first position and a second position. A first current path is formed when power switch 140 is in the first position and a second current path is formed when power switch 140 is in the second position. In the present embodiment, the power switch is a break-before-make single-throw switch, and the current paths are mutually exclusive. The first position is shown. Power switch 140 receives a first control signal 132 through a control line 134 and, responsive to the control signal, switches to the first position or the second position, as known in the art. Power switch 140 includes a common contact shown coupled to a conductor 122. When power switch 140 is in the second position, current flows through conductor 122 and the second current path through a conductor 142, terminal 102, and conductor 62, to the load.

Battery unit 100 further includes a resistive load 150 coupled to power switch 140 via a conductor 144. In the first position, current from battery 120 flows through the first current path and resistive load 150. Selection of the first position disables current flow to the load. In the present embodiment, temperature control logic is included in BMS 130. Temperature control logic receives the temperature signal from temperature sensor 126 and outputs first control signal 132 to place power switch 140 in the first position if the battery temperature is less than a low temperature. In the first position, a resistive load current is enabled, which quickly discharges battery 120 and thereby raises its temperature. In one example, resistive load 150 is sized to raise the battery temperature from about −20° Celsius to at least about 0° Celsius in less than about 3 seconds. In another example, resistive load 150 is sized to raise the battery temperature from about −20° Celsius to at least about 20° Celsius in less than about 3 seconds. Raising the temperature of battery 120 increases the output current of battery 120 for a given charge. The temperature control logic is further configured to place the power switch in the second position if the battery temperature is equal to or greater than the low temperature. In the case where engine 50 is not able to start below 0° Celsius, damage to starter 60 is prevented by first raising the battery temperature above the low temperature and then enabling current to flow to starter 60.

In a variation thereof, a heating device 160 is powered to heat battery unit 100 when power switch 140 is in the first position. Heating device 160 may be a resistive heater and may be coupled to one or more battery cells to heat the battery cells from the outside towards the inside while resistive load 150 heats the battery cells from the inside. Other heating devices may also be used, which may be coupled to the battery cells or supported by frame 110 in any suitable manner.

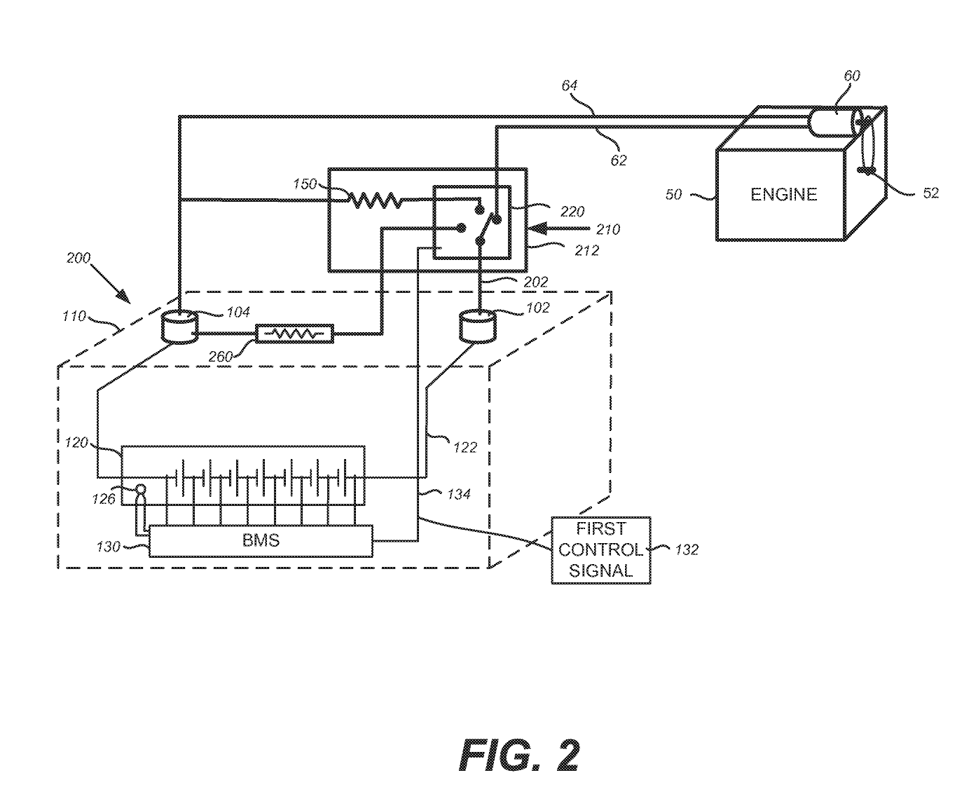

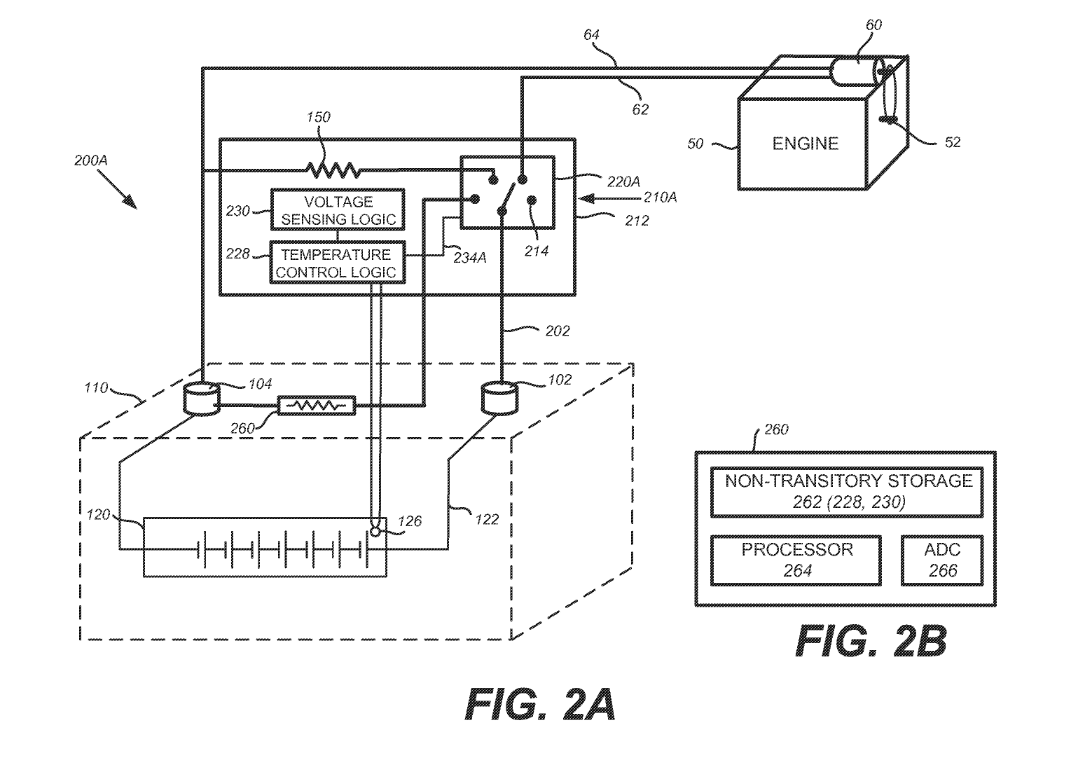

FIG. 2 is a perspective diagram of an embodiment of a battery unit coupled to an external temperature control apparatus. In the present embodiment, the battery unit is denoted by numeral 200 and the temperature control apparatus is denoted by numeral 210. Temperature control apparatus 210 is electrically coupled between battery unit 200 and the load. Temperature control apparatus 210 includes a housing 212, a power circuit operable to enable or disable current flow to the load and resistive load 150 and resistive load 150. An exemplary power circuit is shown, e.g. power switch 220. In the present embodiment, heating device 160 has been substituted with an external heating device 260. As shown, power switch 220 is a double-throw double-pole switch. In the first position, current flows through a conductor 202 and resistive load 150. In the second position, current flows through conductor 202 to the load. In a third position, the poles are wired so that current flows through conductor 202, resistive load 150 and heating device 260. In another embodiment, power switch 220 is a double-throw switch which operates as discussed with reference to FIG. 1, and external heating device 260 is omitted.

FIG. 2A is a perspective diagram of another embodiment of a battery unit coupled to an external temperature control apparatus. In the present embodiment, the battery unit is denoted by numeral 200A and the temperature control apparatus is denoted by numeral 210A. Battery unit 200A is similar to battery unit 200 except without a battery management system. Instead, the temperature control logic is included in temperature control apparatus 210A. Temperature control apparatus 210A includes a power switch 220A, resistive load 150 and a temperature control logic 228. As shown, power switch 220A is a triple-throw double-pole switch. In the first position, current flows through conductor 202 and resistive load 150. In the second position, current flows through conductor 202 to the load. In a third position, the poles are wired so that current flows through conductor 202, resistive load 150 and heating device 260. In the fourth position, current flow is disabled, as indicated by a contact 214, which is not connected to any power conductor. In another embodiment, power switch 220 is a double-throw single-pole switch, external heating device 260 is omitted and the third position disables current flow from the battery.

Temperature control logic 228 receives the battery temperature signal from temperature sensor 126 and transmits the first control signal 232 through a control line 234A to select between the first, second, third or fourth positions of power switch 210A, depending on the number of throws of the power switch. First control signal 232 is configured to cause the switch to enable current flow through resistive load 150 if the battery temperature is low and to the load if the battery temperature equal to or greater than the low temperature. Referring to FIG. 2B, in one example an integrated circuit 260 includes temperature control logic 228, which is stored in a non-transitory storage 262. Integrated circuit 260 comprises a processor 264 to execute temperature control logic 228 and an analog to digital converter (ADC) 266 to read analog signals, such as the battery temperature and voltage. Integrated circuit 260 may comprise a system-on-a-chip integrated circuit, as known in the art. In another example, integrated circuit 260 may be communicatively coupled to an engine control module via a buss, as known in the art, and/or, similarly, to BMS 130.

The term “logic” or “control logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed.

While embodiments of the disclosure have been described with reference to a power switch, any power circuit may be employed as a power switch. The terms “circuit” and “circuitry” refer generally to hardwired logic that may be implemented using various discrete components such as, but not limited to, diodes, bipolar junction transistors, field effect transistors, relays, solid-state relays, contactors, triacs, and other logic and power switches. Some of the circuits may be implemented on an integrated circuit using any of various technologies as appropriate, such as, but not limited to CMOS, NMOS and PMOS. A “logic cell” may contain various circuitry or circuits.

In a further embodiment, temperature control apparatus 210A includes a voltage sensing logic 230. Voltage sensing logic 230 is coupled (connections not shown) to battery 120 and is operable to determine if the battery voltage is too low to power the load, before and/or after the battery has been heated. A minimum battery voltage may be defined which, unless reached, will disable power output by battery unit 200A. Thus, if not enough charge is available to heat the battery and start the engine afterward, voltage sensing logic 230 may either instruct temperature control logic 228 (via a control line, as shown) or the power switch (connection not shown) to disable power output and not heat the battery. In time, the temperature may naturally rise, and the preservation of power may enable the battery to start the engine. Integrated circuit 260 may include voltage sensing logic 230.

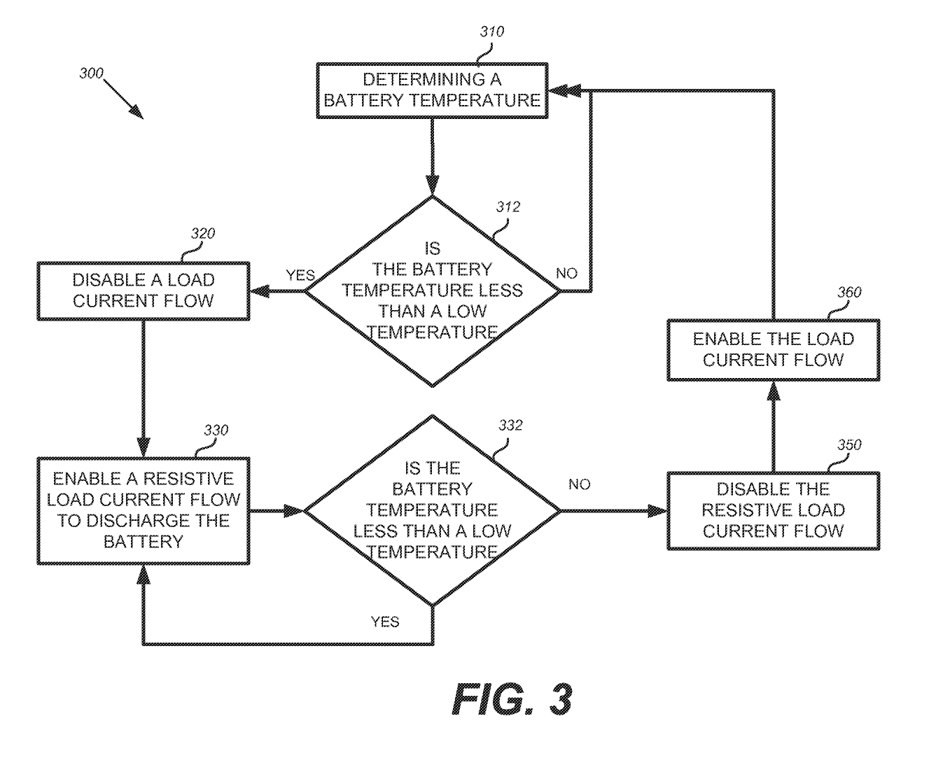

FIG. 3 is a flow chart 300 of an embodiment of a method for controlling a battery. The method begins at 310, with determining a battery temperature. The battery temperature signal may be provided to a BMS or a temperature control logic. At 312, the battery temperature is compared to a low temperature which has been predetermined and stored in non-transitory storage where it may be read by a processor. Alternatively, the low temperature may be converted to a voltage signal and the temperature sensor signal may be compared to the voltage signal by a comparator, such as an operational amplifier or instrumentation amplifier, as known in the art.

The method continues at 320, with disabling a load current flow. The load current flow may be disabled by causing a power switch to open a contact to open a load current path. Exemplary power switches include contactors, solid state switches, triacs, and any other circuit that is controllable by a signal and capable of handling the load current.

The method continues at 330, with enabling a resistive load current flow to discharge the battery. The resistive load current flow may be enabled by causing the power switch to close a contact to close a resistive load current path.

The method continues at 332, when the battery temperature is compared to the low temperature. If the battery temperature has not risen sufficiently, the resistive load current flow continues to discharge the battery. In one variation, the resistive load current flow continues for no longer than a predetermined discharge period.

In a variation of the present embodiment, the resistive load current flow continues for a predetermined discharge period. At the end of the predetermined discharge period, the method continues to 350 without comparing the battery temperature to the low temperature.

The method continues at 350, with disabling the resistive load current flow. Disabling may be caused by the battery temperature rising to the low temperature or ending of the predetermined discharge period.

The method continues at 360, with enabling the load current flow. After the load current flow is enabled, the load may be energized.

In one variation, the battery voltage is compared to a minimum voltage before discharging to heat the battery. If the battery voltage is below the minimum voltage, the battery may not have enough charge to satisfy the load, even after heating, thus the current output by the battery is disabled. If the battery voltage is between the low voltage and the minimum voltage, resistive load current flow is enabled.

In one embodiment, the apparatus includes the load, which comprises an electrical starter of a combustion engine. The electrical starter consumes electrical power to turn over the engine's crankshaft until combustion begins. Several crankshaft rotations may be required for combustion to begin. In one example, the minimum voltage is set to provide three cold cranks of the engine after the battery has been heated. Engines may power vehicles, machinery or a facility such as a factory, an office building or a home. In one variation, the apparatus is a vehicle.

In another variation, enabling a resistive load current also enables current flow to a heating device.

In a further variation, the method includes sizing the resistive load to raise the battery temperature from about −20° Celsius to at least about 0° Celsius in less than about 3 seconds.

In yet another variation, the method includes sizing the resistive load to raise the battery temperature from about −20° Celsius to at least about 20° Celsius in less than about 3 seconds.

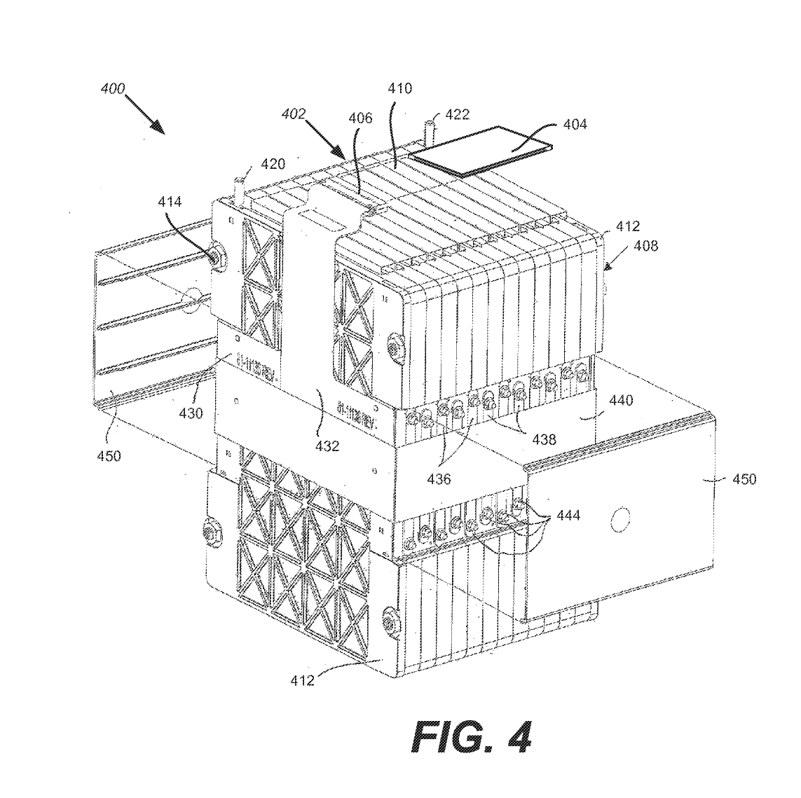

FIG. 4. is a perspective view of an embodiment of a battery unit 400 including a battery module 402 and a BMS and temperature control logic module 404. Battery module 402 is described in more detail in commonly owned U.S. patent application Ser. No. 13/508,770, which is incorporated in its entirety herein by reference. BMS and temperature control logic module 404 is operable to perform the functions described above, such as monitoring battery temperature and voltage, storing low temperature and minimum voltage values and determining whether and when to enable and disable load and resistive load current flows. Battery unit 400 is operationally similar to battery units 100 and 200 in that the units include a BMS and temperature control logic. BMS and temperature control logic module 404 is removably coupled to battery module 402 with an edge connector 406.

Battery module 402 includes a sub assembly module 408 comprising multiple parallel cell assemblies 410 disposed between end plates 412. Four threaded rods 414 tightly secure cell assemblies 410 between end plates 412. Cell assemblies 410 may be electrically coupled in series, in parallel, or both in series and parallel. Power is output through battery terminals 420 and 422. Battery module 402 further comprises a non-terminal side flex circuit 430, a terminal side flex circuit 432, positive cell tab compression bars 436 and negative cell tab compression bars 438 and a tape filament 440 covering compression bars 436 and 438. Compression bars 436 and 438 are secured by washers and nuts 444 and protected by side shields 450.

As discussed previously, certain battery technologies, such as lithium-ion, may become have low power output at low voltage. The foregoing disclosure presents a method and an apparatus for discharging the battery to increase the cold temperature power output. The above detailed description of embodiments of the invention and the examples described therein have been presented only for the purposes of illustration and description. It is therefore contemplated that the present invention cover any and all modifications, variations or equivalents that fall within the spirit and scope of the basic underlying principles disclosed above and claimed herein.

What is claimed is:

1. A method for controlling a battery to power a load, the method comprising:
determining a battery temperature;
disabling a load current if the battery temperature is less than a low temperature;
enabling a resistive load current through a resistive load to discharge the battery at least until the battery temperature is about equal to or greater than the low temperature; and
enabling the load current and disabling the resistive load current if the battery temperature is about equal to or greater than the low temperature.

2. A method as in claim 1, wherein enabling the resistive load current also enables current through a heating device.

3. A method as in claim 2, further comprising positioning the heating device adjacent surfaces of battery cells of the battery to heat the battery cells.

4. A method as in claim 1, further comprising sizing the resistive load to raise the battery temperature from about −20° Celsius to at least about 0° Celsius in less than about 3 seconds.

5. A method as in claim 1, further comprising sizing the resistive load to raise the battery temperature from about −20° Celsius to at least about 20° Celsius in less than about 3 seconds.

6. A method as in claim 1, further comprising measuring a battery voltage and disabling the load current and the resistive load current if the battery voltage is less than a minimum voltage.

7. A method as in claim 6, wherein the load comprises an engine, and the minimum voltage is sufficient to start the engine after discharging the battery through the resistive load.

8. An apparatus for controlling a battery to power a load, the apparatus comprising:
a power circuit operable to selectively form a first current path to enable a first current therethrough and to selectively form a second current path to enable a second current therethrough, the first current and the second current being disabled when the first current path and the second current path, respectively, are not formed;
a resistive load coupled to the power circuit such that at least a portion of the first current flows through the resistive load when the first current path is selectively formed;
temperature control logic configured to receive a temperature signal corresponding to a battery temperature and to output a first control signal to cause the power circuit to form the first current path if the battery temperature is less than a low temperature and to cause the power circuit to form the second current path if the battery temperature is equal to or greater than the low temperature.

9. An apparatus as in claim 8, wherein the power circuit is configured to open the first current path before forming the second current path.

10. An apparatus as in claim 8, wherein the apparatus is part of the battery.

11. An apparatus as in claim 8, wherein the battery includes a battery frame, and the power circuit and the resistive load are positioned within the frame.

12. An apparatus as in claim 8, wherein the battery further comprises a temperature sensor, multiple battery cells and a battery management system (BMS) configured to manage the multiple battery cells, wherein the BMS includes the temperature control logic.

13. An apparatus as in claim 8, further comprising a housing supporting the power circuit and the resistive load.

14. An apparatus as in claim 13, wherein the housing also supports the temperature control logic.

15. An apparatus as in claim 8, wherein the resistive load is sized to raise the battery temperature from about −20° Celsius to at least about 0° Celsius in less than about 3 seconds.

16. An apparatus as in claim 8, wherein the resistive load is sized to raise the battery temperature from about −20° Celsius to at least about 20° Celsius in less than about 3 seconds.

17. An apparatus as in claim 8, further comprising voltage sensing logic configured to open the first current path and the second current path to disable battery current flow if the battery voltage is less than a minimum voltage.

18. An apparatus as in claim 8, wherein the apparatus is a vehicle comprising the engine.

19. An integrated circuit operable to control a battery to power a load, the integrated circuit comprising temperature logic configured for:
determining a battery temperature;
disabling a load current if the battery temperature is less than a low temperature;
enabling a resistive load current through a resistive load to discharge the battery at least until the battery temperature is about equal to or greater than the low temperature; and
enabling the load current and disabling the resistive load current if the battery temperature is about equal to or greater than the low temperature.

20. An integrated circuit as in claim 19, the integrated circuit further comprising voltage sensing logic configured to measure a battery voltage and disabling the load current and the resistive load current if the battery voltage is less than a low voltage.
